(19) United States
(12) Patent Application Publication
(10) Pub. No.: US 2018/0364105 A1
(43) Pub. Date: Dec. 20, 2018

(54) ISO-FOCUS CONTROL SYSTEM FOR EMISSION LASER LIGHT AND TARGET DETECTION LIGHT

(71) Applicant: CHENGDU ANTI PHOTOELECTRIC TECHNOLOGY CO. LTD, CHENGDU (CN)

(72) Inventors: ZHOU LIAO, CHENGDU (CN); DELETU MO, CHENGDU (CN); YONGGUANG ZHANG, CHENGDU (CN)

(21) Appl. No.: 16/008,412

(22) Filed: Jun. 14, 2018

(30) Foreign Application Priority Data
Jun. 16, 2017 (CN) 201710457000.8

(51) Int. Cl. G01J 9/00; G02B 27/10; G02B 26/08; F41H 11/02

(52) U.S. Cl. CPC G01J 9/00; F41H 11/02; G02B 26/0825; G02B 27/106

(57) ABSTRACT

The invention relates to an iso-focus control system for emission laser light and target detection light, including a beam iso-focus detection unit, a control unit, a target light defocusing correction unit and an emission laser light defocusing correction unit; wherein the beam iso-focus detection unit is configured to detect the defocusing amount of the target detection light and the defocusing amount of the emission laser light; the control unit is configured to control the target light defocusing correction unit according to the defocusing amount of the target detection light, and control the emission laser light defocusing correction unit according to the defocusing amount of the emission laser light so that the difference between the defocusing amounts of the corrected target detection light and the corrected emission laser light is within a set range.

### CROSS-REFERENCE TO RELATED APPLICATIONS

This application claims priority to Chinese Patent Application No. 201710457000.8 with a filing date of Jun. 16, 2017. The content of the aforementioned applications, including any intervening amendments thereto, are incorporated herein by reference.

### TECHNICAL FIELD

The invention relates to the field of the counter-manufacturing of an UAV (Unmanned Aerial Vehicle), in particular to an iso-focus control system applied for emission laser light and target detection light of an UAV laser light snipe system.

### BACKGROUND OF THE PRESENT INVENTION

The illegal flying of an UAV (Unmanned Aerial Vehicle) poses a threat to the public safety of a country, flight safety and even air defense security. For example, the UAV is used to steal a photograph, steal information and carry a substance that endangers the public safety, for another example, the occurrence of an UAV dark flight at an airport results in a large number of flights being delayed and causes significant losses.

A UAV laser snipe system is an UAV system that uses laser light to strike a target, in order to accurately hit the target, the laser light generated by the laser shall be accurately focused on the target, that is, emission laser light and target detection light meet the requirement of iso-focus, therefore, to guarantee the iso-focus of the emission laser light and the target detection light is a technical problem that shall be solved to achieve the target's precision strike.

### SUMMARY OF PRESENT INVENTION

The invention aims to provide an iso-focus control system applied for emission laser light and target detection light of an UAV laser light snipe system. Therefore, the embodiment of the present invention provides the following technical solution:

Solution 1: an iso-focus control system for emission laser light and target detection light comprises a beam iso-focus detection unit, a control unit, a target light defocusing correction unit and an emission laser light defocusing correction unit;

wherein the beam iso-focus detection unit is configured to detect the defocusing amount of target detection light and the defocusing amount of emission laser light;

the control unit is configured to control the target light defocusing correction unit according to the defocusing amount of the target detection light, and control the emission laser light defocusing correction unit according to the defocusing amount of the emission laser light;

the target light defocusing correction unit is configured to adjust the defocusing amount of the target detection light;

the target light defocusing correction unit is configured to adjust the defocusing amount of the emission laser light; by adjusting the target detection light and the emission laser light, the adjusted difference between the defocusing amount of the target detection light and the defocusing amount of the emission laser light is within a set range, and preferably approaches zero.

Solution 2: an iso-focus control system for emission laser light and target detection light comprises a beam iso-focus detection unit, a control unit, and a target light defocusing correction unit;

wherein the beam iso-focus detection unit is configured to detect the defocusing amount of target detection light and the defocusing amount of emission laser light;

the control unit is configured to control the target light defocusing correction unit according to the defocusing amount of the target detection light and the defocusing amount of the emission laser light;

the target light defocusing correction unit is configured to adjust the defocusing amount of the target detection light so that the difference between the defocusing amount of the adjusted target detection light and the defocusing amount of the emission laser light is within a set range, and preferably approaches zero.

Solution 3: an iso-focus control system for emission laser light and target detection light comprises a beam iso-focus detection unit, a control unit, and an emission laser light defocusing correction unit;

wherein the beam iso-focus detection unit is configured to detect the defocusing amount of target detection light and the defocusing amount of emission laser light;

the control unit is configured to control the emission laser light defocusing correction unit according to the defocusing amount of the target detection light and the defocusing amount of the emission laser light;

the emission laser light defocusing correction unit is configured to adjust the defocusing amount of the emission laser light so that the difference between the defocusing amount of the target detection light and the defocusing amount of the adjusted emission laser light is within a set range, and preferably approaches zero.

The embodiment of the present invention further provides a beam iso-focus detection device, comprising a light splitting unit, a retroreflector unit, and a beam defocusing detection sensor unit; the light splitting unit transmits one part of emission laser light to the retroreflector unit, the laser light entering the retroreflector unit is reflected back by a retroreflector, is reflected by the light splitting unit, and then enters the beam defocusing detection sensor unit to obtain the defocusing amount of the emission laser light, the target detection light from a target is transmitted through the light splitting unit and then enters the beam defocusing detection sensor unit to obtain the defocusing amount of the target detection light.

The embodiment of the present invention further provides a beam iso-focus detection device in another structure, comprising a light splitting unit, a retroreflector unit, and a beam defocusing detection sensor unit; the light splitting unit transmits target detection light to the retroreflector unit, the target detection light entering the retroreflector unit is reflected back by a retroreflector, is reflected by the light splitting unit, and then enters the beam defocusing detection sensor unit to obtain the defocusing amount of the target detection light, the light splitting unit transmits one part of emission laser light to the beam defocusing detection sensor unit to obtain the defocusing amount of the emission laser light.

Compared with the prior art, the present invention has the following beneficial effects: In the present invention, the difference between the defocusing amount of the emission laser light and the defocusing amount of the target detection light can be detected by the beam iso-focus detection unit, and is corrected by the correction unit when the requirement is not met, thereby being capable of ensuring the iso-focus of the emission laser light and the target detection light and realizing that the emission laser light can be precisely focused on a target.

### DESCRIPTION OF THE DRAWINGS

In order to more clearly explain the technical solutions of the embodiments of the present invention, the drawings used in the embodiments will be briefly described below, it should be understood that the following drawings merely illustrate certain embodiments of the present invention and therefore should not be taken as limiting the scope, for a person of ordinary skill in the art, other related drawings may also be obtained according to these drawings without any creative work.

FIG. 1 is a schematic diagram of an iso-focus control system for a structure according to an embodiment of the present invention.

FIG. 2 is a schematic diagram of an iso-focus control system for another structure according to an embodiment of the present invention.

FIG. 3 is a schematic diagram of an iso-focus control system for another structure according to an embodiment of the present invention.

FIG. 4 is a schematic diagram of a beam iso-focus detection unit of a structure according to an embodiment of the present invention.

FIG. 5 is a schematic diagram of a beam iso-focus detection unit for another structure according to an embodiment of the present invention.

### REFERENCE SIGNS IN THE DRAWINGS

10—Beam Iso-Focus Detection Unit; 20—Control Unit; 30—Target Light Defocusing Correction Unit; 40—Emission Laser Light Defocusing Correction Unit; 50—Target Detection Light; 60—Emission Laser Light; 101—Light Splitting Unit; 102—Retroreflector Unit; 103—Beam Defocusing Detection Sensor Unit; 105—Signal Line; 106—Part Of The Emission Laser Light Reflected by the Light Splitting Unit; 107—Part of The Emission Laser Light Transmitted by The Light Splitting Unit; 108—Emission Laser Light Reflected by the Retroreflector Unit; 109—Target Detection Light Reflected by the Retroreflector Unit.

### DETAILED DESCRIPTION OF PREFERRED EMBODIMENTS

The following will clearly and completely describe the technical solutions in the embodiments of the present invention with reference to the accompanying drawings in the embodiments of the present invention, obviously, the described embodiments are only a part of the embodiments of the present invention, not all of the embodiments. The components of an embodiment of the invention, which are generally described and illustrated in the figures herein, may be arranged and designed in a wide variety of different configurations. Thus, the following detailed description of embodiments of the invention provided in the drawings is not intended to limit the scope of the invention as claimed, but is merely representative of selected embodiments of the invention. All other embodiments obtained by those skilled in the art based on the embodiments of the present invention without any creative work fall within the protection scope of the present invention.

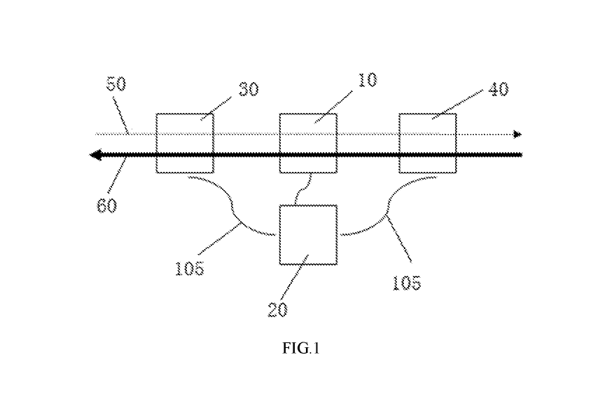

Referring to FIGS. 1-3. The embodiment provides an iso-focus control system for emission laser light and target detection light, the system comprises a beam iso-focus detection unit 10, a control unit 20, a target light defocusing correction unit 30 and/or an emission laser light defocusing correction unit 40;

wherein the beam iso-focus detection unit 10 is configured to detect the defocusing amount of the target detection light and the defocusing amount of the emission laser light. The control unit 20 is used for data processing and fusion of the defocusing amount of the target detection light and the defocusing amount of the emission laser that are output by the beam iso-focus detection unit 10, and then controls the target light defocusing correction unit 30 and the emission laser light defocusing correction unit 40, respectively, or controls one of the target light defocusing correction unit 30 and the emission laser light defocusing correction unit 40 according to the difference between the defocusing amount of the target detection light and the defocusing amount of the emission laser light, and ensure that the iso-focus of the emission laser light and the target detection light.

The target light defocusing correction unit 30 and the emission laser light defocusing correction unit 40 can employ a deformable mirror or a component that can change the defocusing amount of a beam (for example, a secondary mirror of a telescope for receiving target light, or a secondary mirror of an expanded beam system for emitting a laser light expanded beam), The control unit transmits a control signal to control the target light defocusing correction unit 30 and/or the emission laser light defocusing correction unit 40 to adjust accordingly.

In the solution shown in FIG. 1, an iso-focus control system comprises the beam iso-focus detection unit 10, the control unit 20, the target light defocusing correction unit 30 and the emission laser light defocusing correction unit 40, wherein the beam iso-focus detection unit 10 detects the defocusing amount of the target detection light and the defocusing amount of the emission laser light, respectively, On the one hand, the control unit 20 controls the target light defocusing correction unit 30 according to the defocusing amount of the target detection light, so as to adjust the defocusing amount of the target detection light so that the defocusing amount of the adjusted target detection light is within a set range, and preferably approaches zero, On the other hand, the control unit 20 controls the emission laser light defocusing correction unit 40 according to the defocusing amount of the emission light, so as to adjust the defocusing amount of the emission laser light so that the defocusing amount of the adjusted emission laser light is within a set range, and preferably approaches zero.

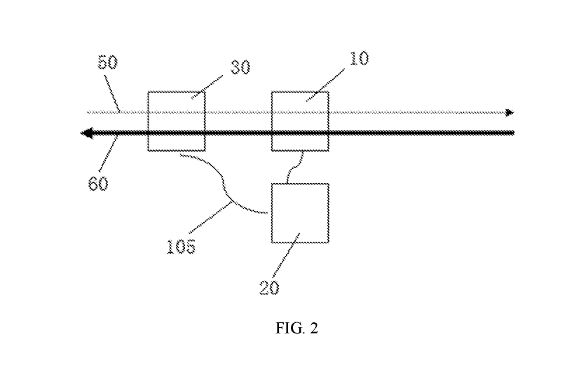

In the solution shown in FIG. 2, an iso-focus control system comprises a beam iso-focus detection unit 10, a control unit 20 and a target light defocusing correction unit 30, the beam iso-focus detection unit 10 detects the defocusing amount of target detection light and the defocusing amount of emission laser light, respectively, the control unit 20 calculates the difference of the defocusing amounts between two beams according to the two defocusing amounts, controls the target light defocusing correction unit 30 to adjust the defocusing amount of the target detection light so that the difference between the defocusing amount of the target detection light and the defocusing amount of the emission laser light is within a set range, and preferably approaches zero.

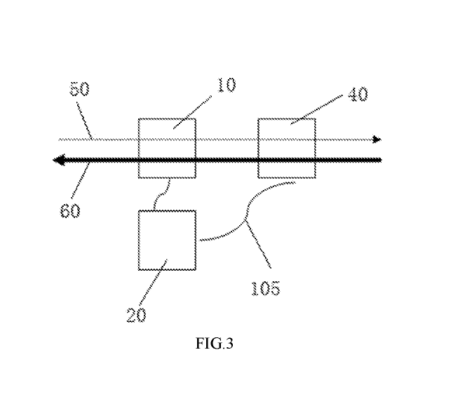

In the solution shown in FIG. 3, an iso-focus control system comprises a beam iso-focus detection unit 10, a control unit 20 and a target light defocusing correction unit 40, the beam iso-focus detection unit 10 detects the defocusing amount of target detection light and the defocusing amount of emission laser light, respectively, the control unit 20 calculates the difference between the defocusing amounts between two beams according to the two defocusing amounts, controls the emission laser light defocusing correction unit 40, and implements the correction of the defocusing amount of the emission laser light so that the difference between the defocusing amount of the target detection light and the defocusing amount of the emission laser light is within a set range, and preferably approaches zero.

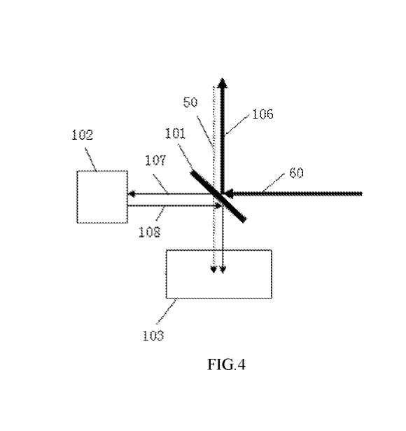

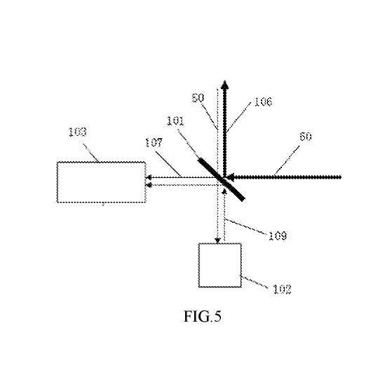

Referring to FIGS. 4-5. The beam iso-focus detection unit 10 comprises a beam splitting unit 101, a retroreflector unit 102, a beam defocusing detection sensor unit 103 (such as a Hartmann wavefront sensor or a curvature wavefront sensor that can directly detect the defocusing amount of a beam).

In the structure shown in FIG. 4, One surface of the light splitting unit 101 is coated with an optical film having a high reflectance to the emission laser light 60 and an optical film having a high transmittance to the target detection light 50, and the other surface thereof is coated with an optical film having a high transmittance to both the emission laser light 60 and the target detection light 50. After the emission laser light 60 passes through the light splitting unit 101, one part of the energy (106) is reflected off to strike a target, and the other part of the energy (107) passes through the light splitting unit 101 and enters the retroreflector unit 102, the laser light entering the retroreflector unit 102 is reflected back (108), is reflected by the light splitting unit 101, and then enters the beam defocusing detection sensor unit 103 to obtain the defocusing amount of the emission laser light; the target detection light 50 is transmitted through the light splitting unit 101 and then enters the beam defocusing detection sensor unit 103 to obtain the defocusing amount of the target detection light.

In the structure shown in FIG. 5, One surface of the light splitting unit 101 is coated with an optical film having a transmittance to the target detection light 50 and an optical film having a high reflectance to the emission laser light 60, and the other surface thereof is coated with an optical film having a high transmittance to both the emission laser light 60 and the target detection light 50. After the emission laser light 60 passes through the light splitting unit 101, one part of the energy (106) is reflected off to strike a target, and the other part of the energy (107) passes through the light splitting unit 101 and enters the beam defocusing detection sensor unit 103 to obtain the defocusing amount of the emission laser light; the target detection light 50 passes through the light splitting unit 101 and enters the retroreflector unit 102, the target detection light 50 entering the retroreflector unit 102 is reflected back (109), is reflected by the light splitting unit 101, and then enters the beam defocusing detection sensor unit 103 to obtain the defocusing amount of the target detection light.

the retroreflector unit comprises one retroreflector array consisting of a plurality of the retroreflectors to realize aperture splitting and reflection of an input beam.

The above description is only a specific embodiment of the present invention, but the scope of the present invention is not limited thereto, any person skilled in the art can easily conceive changes or replacements within the technical scope disclosed by the present invention, which should all fall within the protection scope of the present invention.

We claim:

1. An iso-focus control system for emission laser light and target detection light, including a beam iso-focus detection unit, a control unit, a target light defocusing correction unit and an emission laser light defocusing correction unit;
wherein the beam iso-focus detection unit is configured to detect the defocusing amount of the target detection light and the defocusing amount of the emission laser light;
the control unit is configured to control the target light defocusing correction unit according to the defocusing amount of the target detection light, and control the emission laser light defocusing correction unit according to the defocusing amount of the emission laser light;
the target light defocusing correction unit is configured to adjust the defocusing amount of the target detection light;
the target light defocusing correction unit is configured to adjust the defocusing amount of the emission laser light.

2. The iso-focus control system for the emission laser light and the target detection light according to claim 1, characterized in that the beam iso-focus detection unit comprises a light splitting unit, a retroreflector unit, and a beam defocusing detection sensor unit; the light splitting unit transmits one part of the emission laser light to the retroreflector unit, the laser light entering the retroreflector unit is reflected back by the retroreflector, is reflected by the light splitting unit, and then enters the beam defocusing detection sensor unit to obtain the defocusing amount of the emission laser light, the target detection light from the target is transmitted through the light splitting unit and then enters the beam defocusing detection sensor unit to obtain the defocusing amount of the target detection light.

3. The iso-focus control system for the emission laser light and the target detection light according to claim 1, characterized in that the beam iso-focus detection unit comprises a light splitting unit, a retroreflector unit, and a beam defocusing detection sensor unit; the light splitting unit transmits the target detection light to the retroreflector unit, the target detection light entering the retroreflector unit is reflected back by a retroreflector, is reflected by the light splitting unit, and then enters the beam defocusing detection sensor unit to obtain the defocusing amount of the target detection light, the light splitting unit transmits one part of the emission laser light to the beam defocusing detection sensor unit to obtain the defocusing amount of the emission laser light.

4. The iso-focus control system for the emission laser light and the target detection light according to claim 2, characterized in that the retroreflector unit comprises one retroreflector array consisting of a plurality of the retroreflectors.

5. An iso-focus control system for emission laser light and target detection light according to claim 1, including a beam iso-focus detection unit, a control unit, and a target light defocusing correction unit;
wherein the beam iso-focus detection unit is configured to detect the defocusing amount of target detection light and the defocusing amount of emission laser light;
the control unit is configured to control the target light defocusing correction unit according to the defocusing amount of the target detection light and the defocusing amount of the emission laser light;
the target light defocusing correction unit is configured to adjust the defocusing amount of the target detection light so that the difference between the defocusing amount of the adjusted target detection light and the defocusing amount of the emission laser light is within a set range.

6. An iso-focus control system for emission laser light and target detection light according to claim 1, including a beam iso-focus detection unit, a control unit, and an emission laser light defocusing correction unit;
wherein the beam iso-focus detection unit is configured to detect the defocusing amount of target detection light and the defocusing amount of emission laser light;
the control unit is configured to control the emission laser light defocusing correction unit according to the defocusing amount of the target detection light and the defocusing amount of the emission laser light;
the emission laser light defocusing correction unit is configured to adjust the defocusing amount of the emission laser light so that the difference between the defocusing amount of the target detection light and the defocusing amount of the adjusted emission laser light is within a set range.

7. A beam iso-focus detection device, comprising a light splitting unit, a retroreflector unit, and a beam defocusing detection sensor unit; the light splitting unit transmits one part of emission laser light to the retroreflector unit, the laser light entering the retroreflector unit is reflected back by a retroreflector, is reflected by the light splitting unit, and then enters the beam defocusing detection sensor unit to obtain the defocusing amount of the emission laser light, the target detection light from a target is transmitted through the light splitting unit and then enters the beam defocusing detection sensor unit to obtain the defocusing amount of the target detection light.

8. A beam iso-focus detection device, comprising a light splitting unit, a retroreflector unit, and a beam defocusing detection sensor unit; the light splitting unit transmits target detection light to the retroreflector unit, the target detection light entering the retroreflector unit is reflected back by a retroreflector, is reflected by the light splitting unit, and then enters the beam defocusing detection sensor unit to obtain the defocusing amount of the target detection light, the light splitting unit transmits one part of emission laser light to the beam defocusing detection sensor unit to obtain the defocusing amount of the emission laser light.
